(19) United States
(12) Patent Application Publication
(10) Pub. No.: US 2026/0285367 A1
(43) Pub. Date: Sep. 24, 2026

(54) VEHICLE DEPLOYMENT UNDER DIFFERENT AND CHANGING CONDITIONS USING META-LEARNING

(71) Applicant: TOYOTA MOTOR ENGINEERING & MANUFACTURING NORTH AMERICA, INC., PLANO, TX (US)

(72) Inventor: ROHIT GUPTA, Santa Clara, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 19/083,331

(22) Filed: Mar. 18, 2025

(51) Int. Cl. B60W 60/00; G06N 20/00

(52) U.S. Cl. CPC B60W 60/0015; G06N 20/00

(57) ABSTRACT

A system includes one or more sensor systems and one or more processors including a meta-learning component and an adjustment component. The processors perform operations including, based on sensor data characterizing an environment and based on inductive inferences across historical environments, generating initialization commands to initialize models for vehicle navigation, outputting, by the initialized models, navigation commands that, when executed, perform navigation actions on the vehicle, in response to execution of the one or more navigation commands, and depending on performance metrics that measure a level of performance of the execution of the navigation commands, selectively adjusting the one or more initialization commands and the initialized models, and based on sensor data characterizing a new environment, the selectively adjusted initialization commands, and inductive inferences across the historical environments and the environment, generating new initialization commands for vehicle navigation in the new environment.

### TECHNICAL FIELD

The present disclosure relates generally to adaptation of an autonomous vehicle to different conditions. Some aspects of the disclosure relate to meta-learning to adjust navigation of an autonomous vehicle, dynamically and in near real-time, to the different conditions.

### DESCRIPTION OF RELATED ART

Autonomous or semi-autonomous (hereinafter “autonomous”) vehicle systems need to navigate across a gamut of different conditions, including weather conditions, traffic conditions, road conditions, behavioral conditions, cultural conditions, and other rare or extreme conditions. Currently, autonomous vehicle systems have limited ability to safely and efficiently adapt to different conditions. In some circumstances, autonomous vehicle systems may require extensive training in order to be deployed under different conditions. Often, this training process consumes vast amounts of computing resources and time. Additionally, even after extensive training, autonomous vehicle systems may not even be capable of safe deployment under certain conditions.

### BRIEF SUMMARY OF THE DISCLOSURE

According to various embodiments of the disclosed technology, a system associated with a vehicle (e.g., an ego vehicle) comprises one or more sensor systems configured to obtain sensor data characterizing an environment within a threshold distance of the ego vehicle. The one or more sensor systems may include any of a camera, Lidar, radar, or sensor of any other modality. The one or more sensor systems may further include inertial measurement units (IMUs) used to temporally align, or synchronize, sensor data from the one or more sensor systems. The system comprises one or more processors. The system comprises a memory storing instructions that, when executed by the one or more processors, cause the system to perform operations. The operations include, based on sensor data characterizing an environment and based on one or more inductive inferences across historical environments, generating one or more initialization commands to initialize one or more models for vehicle navigation; outputting, by the one or more initialized models, one or more navigation commands that, when executed, perform one or more navigation actions on the vehicle; in response to execution of the one or more navigation commands, and depending on one or more safety metrics that measure a level of safety of the execution of the one or more navigation commands, selectively adjusting the one or more initialization commands and the one or more initialized models; and based on sensor data characterizing a new environment, the one or more selectively adjusted initialization commands, and one or more inductive inferences across the historical environments and the environment, generating one or more new initialization commands for vehicle navigation in the new environment.

In some embodiments, the instructions that, when executed by the one or more processors, further cause the system to perform: prior to generating the one or more initialization commands, preprocessing the sensor data,. The preprocessing comprises: normalizing any different formats of the sensor data to a common format; temporally aligning the sensor data; extracting one or more features based on the normalized and temporally aligned sensor data; and generating one or more feature vectors corresponding to the one or more extracted features. The instructions further cause the system to perform: generating one or more classification labels to classify the normalized and temporally aligned sensor data; and wherein the generating of the one or more initialization commands is based on the one or more classification labels and the one or more feature vectors.

In some embodiments, the sensor data comprises camera data or Lidar data, temporally aligning of the sensor data comprises synchronizing the sensor data with inertial readings from one or more inertial measurement units (IMUs), the one or more initialization commands modify or set one or more parameters within the one or more models, and the instructions that, when executed by the one or more processors, cause the system to perform initializing the one or more models based on the one or more initialization commands.

In some embodiments, the safety metrics comprise a minimum following distance over a period of time and a degree of conformity in following a lane, and selectively adjusting the one or more initialization commands comprises: in response to the level of safety failing to satisfy a threshold level of safety: based on a type or an extent of a safety failure, adjusting the one or more initialization commands and at least one of the one or more initialized models; outputting, by the one or more adjusted initialized models, one or more adjusted navigation commands; and based on a level of safety of execution of the adjusted navigation commands, modifying one or more adjustment protocols that regulate adjustment of the one or more initialized models. In some embodiments, the degree of conformity in following a lane is based on an extent or proportion in which the vehicle stays within an intended lane, or an extent to which the vehicle stays at or near a center of an intended lane during navigation.

In some embodiments, the adjusting of the one or more initialized models comprises: outputting, based on the characterized environment, one or more adjustment protocols for generating a tuning command; generating the tuning command based on the one or more adjustment protocols; and applying the tuning command to adjust the one or more initialized models, wherein the adjusting of the one or more initialized models comprises adjusting one or more parameters corresponding to the one or more initialized models.

In some embodiments, the instructions that, when executed by the one or more processors, further cause the system to perform: modifying the one or more adjustment protocols; in response to a level of safety of execution of the adjusted navigation commands failing to satisfy the threshold level of safety, further modifying the one or more adjustment protocols until the level of safety of execution of the one or more further modified adjustment protocols satisfies the threshold level of safety.

In some embodiments, the initializing of the one or more models comprises activating a subset of the one or more models and deactivating one or more remaining models, and the sensor data comprises one or more navigation conditions of the environment, the navigation conditions comprising any of weather conditions, visibility conditions, traffic conditions, and road geometry conditions.

In some embodiments, the one or more models, prior to initialization, are configured to output one or more navigation commands for a different set of navigation conditions.

In some embodiments, the instructions that, when executed by the one or more processors, further cause the system to perform: modifying the one or more adjustment protocols based on historical modifications to one or more previous adjustment protocols and extents to which the historical modifications resulted in a level of safety of execution that satisfied the threshold level of safety.

In some embodiments, the one or more new initialization commands modify one or more different parameters within the one or more models, the one or more new initialization commands are configured to output one or more new navigation commands specific for the new environment; and the instructions that, when executed by the one or more processors, further cause the system to perform: performing a new initialization on the one or more models based on the one or more new initialization commands; outputting, by the one or more newly initialized models, the one or more new navigation commands that, when executed, perform the one or more navigation actions or new navigation actions on the vehicle; in response to execution of the one or more new navigation commands, obtaining one or more new metrics that measure a new level of safety of the execution of the one or more new navigation commands; in response to the new level of safety failing to satisfy a threshold degree of safety: based on a type or an extent of a safety failure, adjusting the one or more new initialization commands and at least one of the one or more newly initialized models; outputting, by the one or more adjusted newly initialized models, one or more adjusted new navigation commands; based on a degree to which resulting execution of the adjusted new navigation commands satisfies the threshold degree of safety, modifying one or more new adjustment protocols that regulate adjustment of the one or more newly initialized models; and based on sensor data characterizing the environment, the one or more adjusted new navigation commands, and one or more inductive inferences from the historical environments, the new environment, and the environment, generating one or more second modified initialization commands for vehicle navigation in the new environment.

In some embodiments, the vehicle system comprises a database system, and at least some of the aforementioned operations are performed remotely from the vehicle system. For example, at least some of the aforementioned operations may be performed by a different database system or an external system such as a cloud or edge computing system. The vehicle system may obtain one or more results of the aforementioned operations via communication with the different database system or the external system.

In some embodiments, the vehicle system includes any or all of a base component, a meta-learning component, an input preparing component, and an adjustment component.

In some embodiments, a computer-implemented method comprises:

A computer-implemented method comprising: based on sensor data characterizing an environment and based on one or more inductive inferences across historical environments, generating one or more initialization commands to initialize one or more models for vehicle navigation; outputting, by the one or more initialized models, one or more navigation commands that, when executed, perform one or more navigation actions on the vehicle; in response to execution of the one or more navigation commands, and depending on one or more performance metrics that measure a level of performance of the execution of the one or more navigation commands, selectively adjusting the one or more initialization commands and the one or more initialized models; and based on sensor data characterizing a new environment, the one or more selectively adjusted initialization commands, and one or more inductive inferences across the historical environments and the environment, generating one or more new initialization commands for vehicle navigation in the new environment.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture including computing components for deploying a vehicle under different conditions using meta-learning, including a navigation adjustment system.

FIG. 4A illustrate an example architecture including detailed components for deploying a vehicle using meta-learning. FIG. 4A includes a detailed block diagram of the navigation adjustment system.

FIG. 4B is a diagram illustrating sequential steps of individual components of the navigation adjustment system and how the individual components collaborate with one another.

FIGS. 5-8 illustrate example implementations of the navigation adjustment system according to different navigation conditions.

FIG. 9 is a diagram illustrating a generated dataset of stored protocols for initialization and tuning.

FIG. 10 is an example computing component that may be used to implement various features of embodiments described in the present disclosure.

The figures are not exhaustive and do not limit the present disclosure to the precise form disclosed.

### DETAILED DESCRIPTION

A computing system of an autonomous or semi-autonomous (hereinafter “autonomous”) ego vehicle may implement a novel paradigm to learn and adapt to changing or previously unencountered navigation conditions without requiring extensive training. The changing or previously unencountered navigation conditions may include a diverse range of conditions that affect, or have at least a threshold likelihood of affecting, navigation of the vehicle. In some embodiments, navigation conditions may include any of geographic locations, environments (e.g., urban, suburban, rural), types of roadways or road geometries, traffic conditions such as traffic density, distribution and speed, environmental conditions such as weather or visibility conditions, navigation norms or customs, navigation behaviors of the ego vehicle or of surrounding vehicles, attributes of the ego vehicle (e.g., size, shape, historical performance) or of surrounding traffic or obstacles, and temporal or infrastructural restrictions associated with a planned navigation path.

The computing system may include a navigation adjustment system. The navigation adjustment system may encompass one or more computing components such as an input preparing component, a meta-learning component, a base component, or an adjustment component. In some embodiments, any or all of these aforementioned components may collaborate to safely and efficiently adapt to changing or previously unencountered navigation conditions while avoiding extensive training. In some embodiments, the different computing components may refer to separate computing commands but may not necessarily be separate physical or virtual processors. In some embodiments, the input preparing component may generate, from inputs such as sensor data, certain representations indicative of current or predicted navigation conditions. These representations may include feature vectors and classification labels, and may be fed into the meta-learning component. In some embodiments, the meta-learning component may initialize the base component depending on current navigation conditions. In some examples, the base component may be configured to generate or output navigation commands to perform certain navigation actions. The adjustment component may selectively adjust, or cause adjustment of, the base component depending on metrics during the navigation actions. In some embodiments, the metrics may measure In one scenario, if certain metrics fall outside of permitted threshold ranges, then the adjustment component may adjust, or cause adjustment of, certain parameters of a model utilized by the base component. This feedback loop ensures continuous improvement and adaptability without manual intervention.

The computing system thus addresses potential limitations associated with autonomous vehicle navigation while improving computing technology, for example in the field of autonomous navigation. The computing system eliminates or reduces an extent of a training process. As a result, training dataset generation and training dataset labelling are avoided, thereby conserving computing resources. Avoiding a training process is particularly crucial in autonomous vehicle navigation both before and after deployment. Training during deployment may result in the ego vehicle being temporarily inoperable or offline. For example, if the computing system suddenly requires training or retraining, the ego vehicle may suddenly stop, or otherwise have its planned operation interrupted. Such downtime, during deployment, not only cause inconvenience but also safety concerns for the ego vehicle and surrounding traffic.

Another benefit of avoiding the training process is overcoming the simulation-to-real-world gap. This gap exists because models trained in simulations often fail to perform adequately in the real-world due to differences in data distribution. The computing system overcomes this gap using few-shot learning techniques which reduces dependency on simulations. Another benefit is that the computing system may be deployed in new geographic regions which may have different road rules, signage, or cultural driving norms or behaviors. The meta-learning component identifies regional navigation conditions in different geographies and generates base component initialization commands corresponding to the regional navigation conditions. The meta-learning component may utilize priors in different previous geographies. The priors may include previous navigation conditions in the different previous geographies and the corresponding previous base component initialization commands. Based on a mapping between the previous navigation conditions and the previous base component initialization commands, the meta-learning component may generate the base component initialization commands.

Yet another computing improvement is freeing up storage space within the computing system which would otherwise be allocated for storage of training datasets. These aforementioned computing improvements improve computing efficiency at least because the computing system is able to allocate more resources and storage space to other computing tasks and is less likely to be overburdened by training dataset generation, training dataset labelling, and training dataset storage. The increase in computing efficiency also improves safety of autonomous vehicle navigation because of improved reaction time to urgent or rapidly changing navigation conditions.

Another computing improvement is related to improved vehicle-to-vehicle (V2V) communication, specifically among computing systems of different vehicles. In particular, different vehicles, such as vehicles within a same fleet, may learn from one another to adapt to different navigation conditions. Such learning among vehicles may occur if, for example, a different vehicle has encountered navigation conditions which the ego vehicle has not encountered. Such V2V communication may facilitate even more efficient learning and adapting to previously unencountered navigation conditions. Moreover, the computing system may be applicable to cooperative tasks like platooning and traffic flow optimization to further streamline fleet operations and reducing congestion.

In some embodiments, the input preparing component may obtain inputs including sensor data from any vehicle or external sensor systems, such as cameras, lidars, radars, or IMUs. Sensor systems may refer to one or more sensors or any associated processing components (e.g., software, hardware, or firmware) to process raw sensor data captured by the sensors. The sensor data may include external data relative to the ego vehicle or internal data including one or more attributes of the ego vehicle. In some embodiments, the external data may be indicative of any or all of the aforementioned or subsequently described navigation conditions. In some embodiments, attributes of the ego vehicle include speed, heading, acceleration, force or torque applied to an actuation or steering component, or an ego vehicle status, such as a status indicative of a disengagement or safe operation. The sensor data may be from a current time period, or within a threshold range of the current time period. In some embodiments, the inputs may further include any navigation commands received or executed by the ego vehicle.

The input preparing component may preprocess the inputs in order to normalize the inputs into a format that is decipherable by the meta-learning component. The preprocessing of the inputs may include normalization of formats or dimensions, synchronization of different sensor modalities or data types, spatial or temporal alignment of the input data. The input preparing component may further extract, from the input data, one or more features and generate feature vectors from the obtained features. The input preparing component may classify or categorize (hereinafter “classify”) current or predicted future navigation conditions based on the preprocessed inputs. The input preparing component may further label the preprocessed inputs according to the classifications.

The labelled, classified and preprocessed (hereinafter “labelled”) inputs, along with the feature vectors, may be fed into the meta-learning component. The meta-learning component may generate initialization commands for the base component, thus enabling the base component to be initialized. In some embodiments, the initialization encompasses parameter initialization. In some embodiments, the initialization commands provide task-specific initialization. In some embodiments, the initialization commands may be generated based on inductive inferences across previous tasks, such as an inductive inference across a distribution of different tasks. These inductive inferences may be manifested as mutual priors that capture inherent connections such as shared parameters across different tasks. These inductive inferences further enhance performance and accuracy of predictions especially in previously unencountered or rare navigation conditions. In some embodiments, tasks may refer to different navigation conditions under which vehicle navigation occurs. In some embodiments, tasks may refer to any autonomous vehicle functionalities across one or more navigation conditions such as different road geometries, or different navigation environments. Some nonlimiting examples of tasks may include perception tasks such as perception of vehicles or other objects, perception of road geometry, perception of lane boundaries, depth estimation, drivable area segmentation, navigating intersections, merging, or changing lanes.

The meta-learning component may generate one or more adjustment protocols for the adjustment component, which may include one or more rules or guidelines of tuning based on the metrics (e.g., navigation metrics or navigation-related metrics) or feedback. For example, assume a situation in which navigation-related metrics indicate that certain ego vehicle attributes fall outside of a permitted range. The adjustment protocols may include one or more rules of how to safety adjust navigation commands to make the ego vehicle attributes fall within the permitted range, without otherwise detrimentally affecting other navigation-related metrics.

The base component may generate navigation commands that, when executed, perform one or more navigation actions such as lane following or obstacle avoidance. The adjustment component may obtain one or more metrics from navigation actions of the ego vehicle and generate a feedback dataset from the one or more metrics. Depending on the metrics or the feedback dataset, the adjustment component may generate a tuning command for the base component in order to adjust the navigation commands. In some embodiments, the tuning command provides few-shot tuning, which tunes the base component in only a few shots or iterations even for rare and safety-critical edge navigation conditions. This enables rapid, near real-time adjustments for handling such situations as well as increasing safety and robustness.

The computing system improves ability of the ego vehicle to effectively and efficiently adapt to a diverse set of new and changing navigation conditions, while reducing a processing and storage footprint. The computing system provides benefits that resolve current problems in computing technology in the field of autonomous vehicles by manifesting computational efficiency and resiliency to changing navigation conditions. Additionally, the computing system provides continuous feedback based on navigation-related metrics to improve future adaptation and initialization. The technologies described herein thus provide technical benefits including improvements in computer technology pertaining to autonomous vehicle navigation.

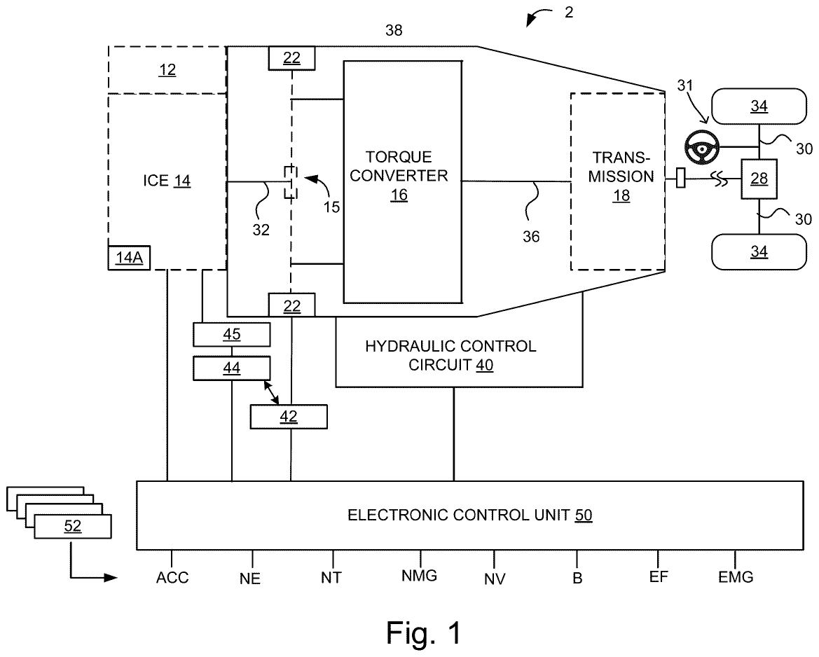

The systems and methods disclosed herein may be implemented with any of a number of different ego vehicles and ego vehicle types. For example, the systems and methods disclosed herein may be used with automobiles, trucks, motorcycles, recreational vehicles and other like on-or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline-or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30. The ego vehicle 2 may include a steering system 31. The steering system 31 may be implemented via electronic power steering (EPS) or steer-by-wire.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and braking. As a more particular example, output torque of the motor 22 can be increased or decreased by electronic control unit 50 through the inverter 42. In some embodiments, the electronic control unit 50 may control the steering system 31.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. In some embodiments, sensors 52 may detect navigation characteristics of the ego vehicle 2. Here, navigation characteristics may include an absolute position, an absolute velocity, an absolute heading, or an absolute acceleration of the ego vehicle 2 or of the obstacle.

In some embodiments, one or more of the sensors 52 may include, or be part of, sensor systems which include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

As evident, sensors 52 may be included to detect not only vehicle conditions but also to detect navigation conditions external to the vehicle, such as of other obstacles, as well. Sensors that might be used to detect external conditions can include, for example, sonar, radar, lidar or other vehicle proximity sensors, and cameras or other image sensors. Thus, in some embodiments, the sensors 52 or a portion or subset thereof may be implemented as, or part of, the aforementioned first sensors, first sensor systems, second sensors, or second sensor systems. Image sensors can be used to detect, for example, objects such as traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit or receive data or other information.

The sensors 52 may be within an interior of a cabin of, or on an exterior of the ego vehicle 2. The sensors 52 may include impairment detecting sensors, such as in-cabin cameras, eye tracking sensors, and steering wheel monitoring systems. In particular, in-cabin cameras may include infrared cameras that monitor an occupant's eyes, face, or head to assess a measure of eye, facial, or head movements or a degree of stability or eye, facial, or head movements.

The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

The ego vehicle 2 may operate under different levels of autonomy, such as any of Society of Automotive Engineers (SAE) levels between L1 and L5. In some embodiments, the ego vehicle 2 may operate under a level of autonomy, such as L1 or L2, that includes or supports Vehicle-to-Everything (V2X) or V2V communication functionality, or other functionalities such as ADAS functionality.

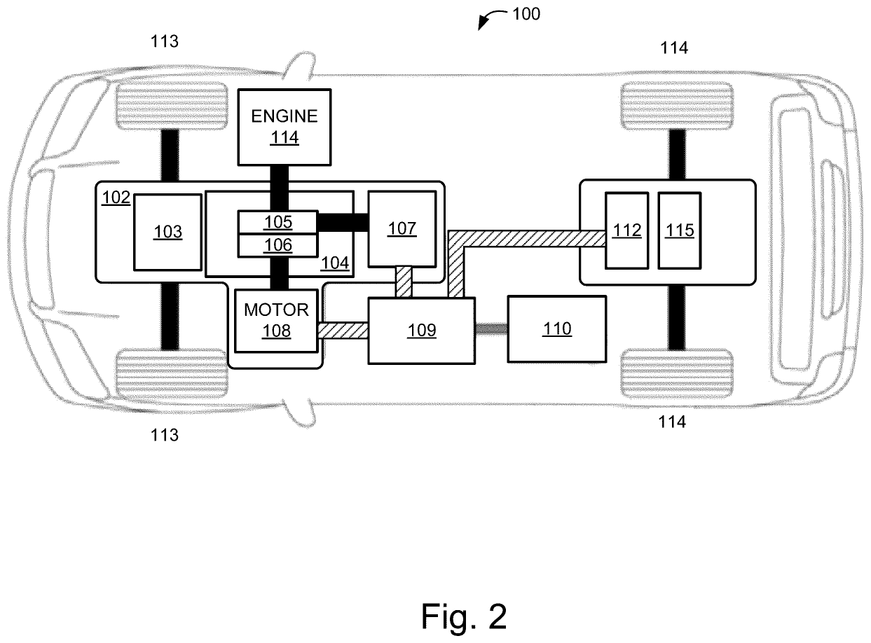

FIG. 2 is another example of an ego vehicle with which systems and methods for adapting to different and changing navigation conditions using meta-learning can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. An ego vehicle may include all or a portion of the components illustrated in FIG. 1 or 2. Other variations of vehicles, such as gasoline powered vehicles, may also be implemented. Any vehicles may be implemented with vehicle platforms.

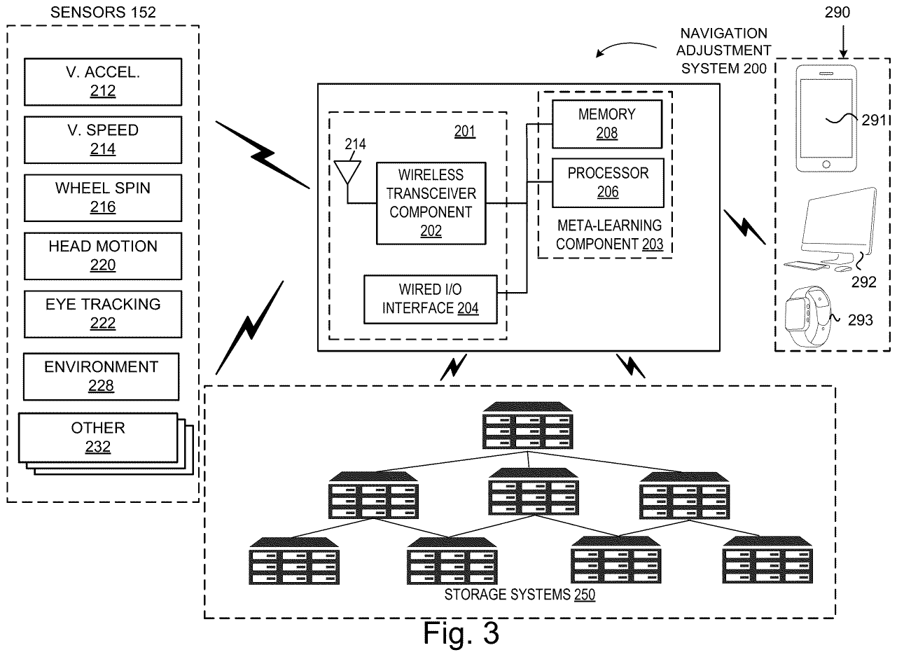

FIG. 3 illustrates an example architecture of a navigation adjustment system 200 for safely and efficiently adapting to different navigation conditions without extensive retraining. In some embodiments, the navigation conditions may include geographic locations, navigation environments (e.g., urban, suburban, rural), types of roadways and road geometries, traffic conditions such as traffic density, distribution and speed, environmental conditions such as weather or visibility conditions, navigation norms or customs (e.g., passing on a left or right side, yielding norms), driving styles or behaviors (e.g., aggressive or passive behaviors) of the ego vehicle 2 or of surrounding traffic, attributes of the ego vehicle (e.g., size, shape, historical performance) or of surrounding traffic or obstacles, and temporal restrictions (e.g., certain roads or portions thereof being closed or inaccessible during a period of time).

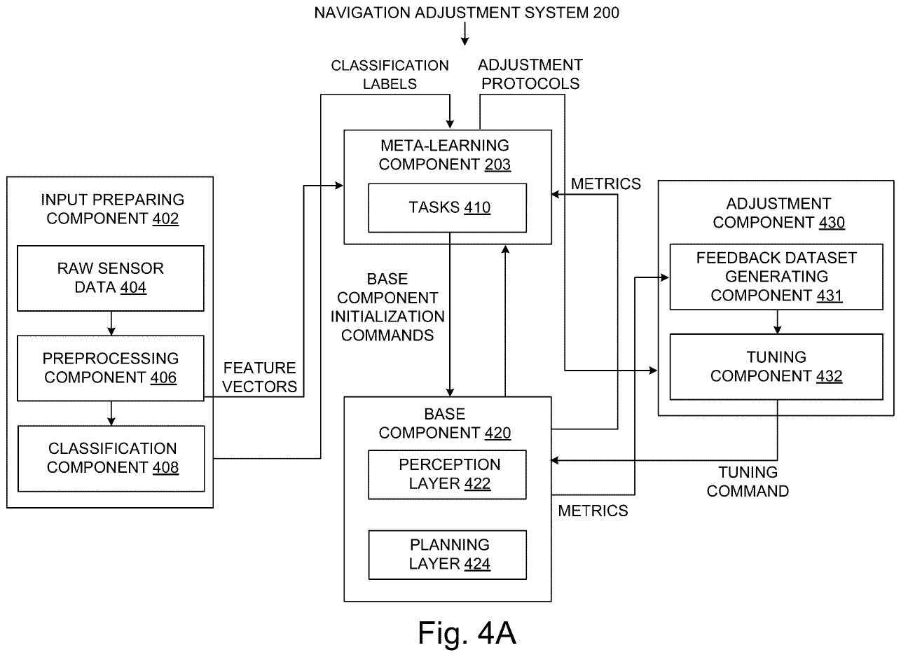

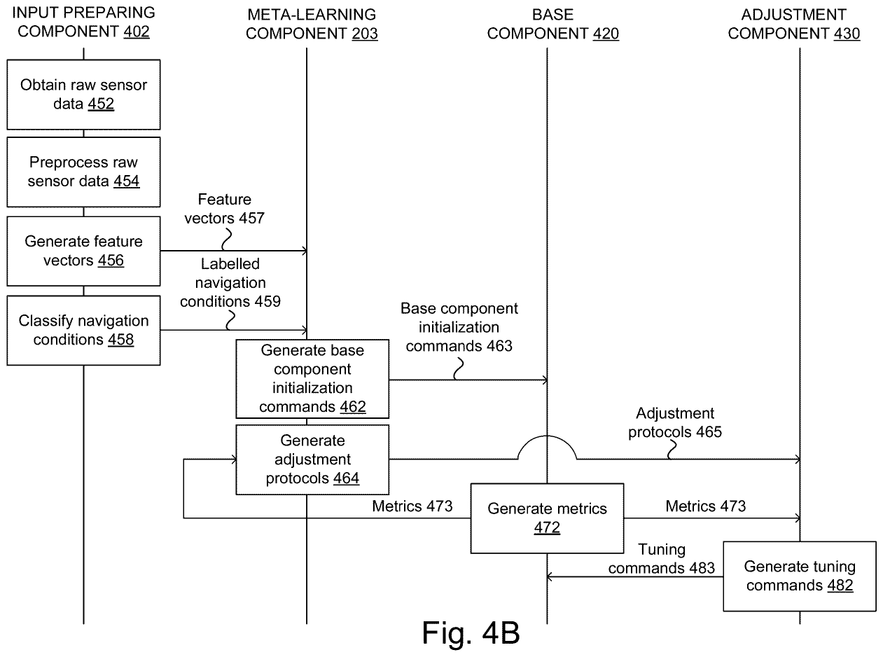

Navigation adjustment system 200 may include a computer system or database system, and may include a meta-learning component 203, among other computing components. Only the meta-learning component 203 is illustrated for simplicity in FIG. 3, and additional components may be present in the navigation adjustment system 200. A more detailed implementation of the navigation adjustment system 200 is illustrated in FIG. 4A and FIG. 4B. In FIG. 3, the meta-learning component 203 may obtain input data, which may include labelled sensor data indicative of one or more navigation conditions. The meta-learning component 203 may obtain one or more feature vectors indicative of characteristics that affect, or have a likelihood of affecting, navigation commands. In some embodiments, the feature vectors may be indicative of, represent, or correspond to the aforementioned navigation conditions. The feature vectors may further be associated with weights indicating their relative priorities. The meta-learning component 203 may generate initialization commands to initialize a component (e.g., a base component) of the navigation adjustment system 200. In some embodiments, the base component generates navigation commands for navigation of the ego vehicle 2. The meta-learning component 203 may also generate adjustment protocols which include one or more rules or guidelines (hereinafter “rules”) of adjusting or tuning the navigation commands or the base component based on navigation-related metrics or feedback. In some embodiments, the initialization commands or the adjustment protocols may be based on cross-task or cross-client knowledge. The initialization commands may capture knowledge from inductive reasoning across the different tasks or clients.

For example, if the base component includes one or more models that generate or output navigation commands, then the adjustment protocols may provide rules that indicate a manner of adjusting the one or more models. Adjustment to the models may encompass activating or deactivating certain models, or adjusting parameters such as weights associated with feature vectors within any of the models, or switching to different models.

Assume a situation in which navigation-related metrics indicate that certain ego vehicle attributes fall outside of a permitted range. The adjustment protocols may include one or more rules of how to safety adjust navigation commands or the base component, in order to make the ego vehicle attributes fall within the permitted range, without otherwise detrimentally affecting other navigation-related metrics. For example, if a specific navigation-related metric falls outside of a certain threshold range, then the rules may specify that under certain circumstances, an existing model may have an attribute adjusted or may be switched in favor of another model.

In this manner, the meta-learning component 203 may conserve computing or other onboard resources by initializing, or causing initialization of, the navigation adjustment system 200 based on current navigation conditions, and generating adjustment protocols for subsequent adjustment or tuning of the navigation adjustment system 200. As a result, the navigation adjustment system 200 may continuously adapt to any navigation conditions without extensive training.

The navigation adjustment system 200 may, according to the initialization and adjustment caused by the meta-learning component 203, perform one or more navigation actions on the ego vehicle 2. The performing of one or more navigation actions, in some embodiments, may include controlling, programming, causing, or implementing one or more navigation actions of the ego vehicle 2. The one or more navigation actions may set or change a navigation characteristic of the ego vehicle 2 (e.g., an ego vehicle navigation characteristic). Controlling navigation actions may refer to generating or outputting navigation commands. In some embodiments, navigation commands may encompass actuation or steering commands directed to one or more actuating or steering components. In some embodiments, additionally or alternatively, navigation commands may encompass rules or guidelines such as following a lane or maintaining a minimum distance from a nearest vehicle or other obstacle.

The navigation adjustment system 200 or the meta-learning component 203 can be implemented as an ECU or as part of an ECU such as, for example electronic control unit 50. In other embodiments, the navigation adjustment system 200 or the meta-learning component 203 can be implemented independently of the ECU. The navigation adjustment system 200 in this example includes a communication component 201, and the meta-learning component 203 includes a processor 206 and memory 208. Other components, such as the aforementioned base component and additional components (e.g., input preparing component, adjustment component) illustrated in FIGS. 4A and 4B, may also include a separate processor and memory. The communication component 201 may include one or more communication interfaces to communicate among the different components. Components of the navigation adjustment system 200 are illustrated as communicating with each other via a data bus, although other communication in interfaces can be included.

The navigation adjustment system 200 may include a plurality of sensors 152, one or more storage systems 250 which may include servers within or associated within the ego vehicle 2, and one or more other devices 290 which may be external to or internally located within the ego vehicle 2. The one or more storage systems 250 may store any of the previously aforementioned data including, but not limited to, any current or historical data of navigation conditions, any stored models used to generate navigation commands, any metrics during navigation, or any feedback datasets.

In some embodiments, the one or more other devices 290 include one or more different computing or mobiles devices 291, 292, or 293, and may be configured to receive a subset (e.g., a portion or all of) outputs from the navigation adjustment system 200, or the meta-learning component 203, either in real-time or in a delayed manner via V2N communication.

Sensors 152, storage systems 250, and one or more other devices 290 can communicate with the radar data augmenting component 210 via a wired or wireless communication interface. Although sensors 152, storage systems 250 and one or more other devices 290 are depicted as communicating with the navigation adjustment system 200, they can also communicate with each other as well as with other vehicle systems.

Returning to the navigation adjustment system 200, the sensors 152 can include, for example, sensors 52 such as those described above with reference to the example of FIG. 1. Sensors 152 can include additional sensors. In the illustrated example, sensors 152 may include state detecting sensors which detect changes in navigation conditions, such as a change in weather or visibility, or a change from an urban to a rural environment. These changes in state may trigger the meta-learning component 203 to generate updated initialization commands corresponding to the changed navigation conditions, update adjustment protocols, or generate updated adjustment protocols.

The sensors 152 may include vehicle acceleration sensors 212, vehicle speed sensors 214, wheelspin sensors 216 (e.g., one for each road wheel), head motion sensors 220 to detect rotational or translational motion of a head of a driver within the ego vehicle 2, eye tracking sensors 222 to detect eye movements of the driver, and environmental sensors 228 (e.g., to detect traffic density, speed of surrounding traffic, weather, air quality, or other environmental conditions). In some embodiments, a degree of change over a period of time in the sensor data from the environmental sensors 228 may affect an action to be determined by the navigation adjustment system 200. For example, if traffic density increases at a higher than threshold rate or a visibility of the environment decreases at a higher than threshold rate, then the navigation adjustment system 200 may be triggered to generate new initialization commands. If the degree of change does not exceed a threshold rate, then the navigation adjustment system 200 may not be triggered to generate new initialization commands.

Additional sensors 232 can also be included as may be appropriate for a given implementation of the navigation adjustment system 200. The additional sensors 232 may be configured to detect or alert for any indications of anomalous behavior of any obstacles, of the ego vehicle 2, or occupants therein.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to detect potential interfering obstacles or generate visual representations, for processor 206 as well as any other suitable information. Memory 208 can be made up of one or more modules of one or more different types of memory, and may be configured to store data and other information as well as operational instructions that may be used by the processor 206.

Although the example of FIG. 3 is illustrated using processor and memory components, as described below with reference to components disclosed herein, the navigation adjustment system 200, including the meta-learning component 203, can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the navigation adjustment system 200, or the meta-learning component 203.

Communication component 201 includes either or both a wireless transceiver component 202 with an associated antenna 205 and a wired I/O interface 204 with an associated hardwired data port (not illustrated). As this example illustrates, communications with the radar data augmenting component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by the meta-learning component 203 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

FIG. 4A illustrates an example implementation of the navigation adjustment system 200. In some embodiments, the navigation adjustment system 200 includes an input preparing component 402, the meta-learning component 203, a base component 420, and an adjustment component 430. The navigation adjustment system 200 may be implemented with fewer or additional components, and any of the components be combined in a single component.

In some embodiments, the input preparing component 402 may obtain inputs including sensor data from any vehicle or external sensor systems, such as cameras, lidars, radars, or IMUs. The sensor data may include external sensor data relative to the ego vehicle or internal sensor data including one or more attributes of the ego vehicle 2. In some embodiments, the external sensor data may include any or all of the aforementioned or subsequently described navigation conditions. In some embodiments, attributes of the ego vehicle 2 include speed, heading, or acceleration of the ego vehicle 2, force or torque applied to, or other status associated with, an actuation or steering component, or an ego vehicle status, such as a status indicative of a disengagement or safe operation of the ego vehicle 2. The sensor data may be from a current time period, or within a threshold range of the current time period. In some embodiments, the inputs may further include navigation commands transmitted to the ego vehicle, including historical or potential navigation commands. The input preparing component may preprocess the inputs in order to normalize the inputs into a format that is decipherable by the meta-learning component 203. The preprocessing of the inputs may include normalization of formats, synchronization of different sensor modalities or data types, reduction of one or more dimensions, spatial or temporal alignment of the input data. As nonlimiting examples, the preprocessing of inputs may include point cloud registration, or reduction of a height dimension from the sensor data.

The input preparing component 402 may further extract, from the input data, one or more features and generate feature vectors from the obtained features. In some embodiments, the features may represent navigation conditions. The input preparing component 402 may classify current or predicted future navigation conditions based on the preprocessed inputs. The input preparing component 402 may further label the preprocessed inputs according to the classifications.

The labelled, classified and preprocessed (hereinafter “labelled”) inputs, along with the feature vectors, may be fed into the meta-learning component 203. The meta-learning component 203 may generate initialization commands for the base component 420, thus enabling the base component 420 to be initialized. In some embodiments, the initialization encompasses parameter initialization for one or more models or layers of the base component 420. In some embodiments, the initialization commands provide task-specific initialization, for one or more tasks 410. In some embodiments, the initialization commands may be generated based on, or encapsulate, inductive inferences across different tasks. These inferences may be manifested as mutual priors that capture inherent connections across different tasks. These inferences further enhances performance and accuracy of predictions especially in previously unencountered or rare navigation conditions. In some embodiments, tasks may refer to different navigation conditions in which navigation occurs. In some embodiments, tasks may refer to any autonomous vehicle functionalities across one or more navigation conditions such as different road geometries, or different navigation environments. Some nonlimiting examples of tasks may include perception tasks such as perception of vehicles or other objects, perception of road geometry, perception of lane boundaries, depth estimation, drivable area segmentation, navigating intersections, merging, or changing lanes.

In some embodiments, the initiation commands may include commands to activate or deactivate certain models within the base component 420, depending on the labelled inputs and the feature vectors. In some embodiments, the initiation commands may include commands to modify certain parameters or weights within one or more particular models of the base component 420.

The meta-learning component 203 may generate one or more adjustment protocols for the adjustment component 430, which may include one or more rules or guidelines of tuning based on the metrics (e.g., navigation-related metrics) or feedback. For example, assume a situation in which navigation-related metrics indicate that certain ego vehicle attributes fall outside of a permitted range. The adjustment protocols may include one or more rules of how to safety adjust navigation commands to make the ego vehicle attributes fall within the permitted range, without otherwise detrimentally affecting other navigation-related metrics. The adjustment protocols may include rules regarding which models may be activated or deactivated in response to certain metrics falling outside of a permitted range, or any permitted ranges or values to which certain parameters or weights within the models may be adjusted.

The base component 420 may generate navigation commands that, when executed, perform one or more navigation actions such as lane following or obstacle avoidance. In some embodiments, the base component 420 may contain a perception layer 422 configured to generate high-level representations based on the sensor data and a planning layer 424 configured to generate trajectories or control signals, or other additional layers. The base component 420 may be initialized by the base component initialization commands from the meta-learning component 203. The base component 420 may perform or otherwise coordinate driving or navigation actions, including outputting control signals related to steering or actuation. For example, the base component 420 may generate control signals that are specifically transmitted to one or more steering or actuation components of the ego vehicle 2. The base component 420 may generate one or more metrics relating to navigation conditions or other performance indicators during navigation, such as any disengagements, collisions, or other safety events, a degree to which the ego vehicle 2 is staying within a lane, following distances to a nearest vehicle or other obstacle, or a degree or frequency to which the ego vehicle 2 is rapidly accelerating or decelerating (e.g., accelerating or decelerating at a lower or higher than threshold rate). The base component 420 may transmit the metrics to the adjustment component 430 or to the meta-learning component 203. The meta-learning component 203 may selectively modify the adjustment protocols in response to the metrics. For example, if the metrics indicate that a particular parameter is outside of a permitted range, then the meta-learning component 203 may modify the adjustment protocols in order to specifically address the particular parameter being outside of the permitted range.

The adjustment component 430 may obtain the metrics from the base component 420. In some embodiments, the adjustment component 430 may include a feedback dataset generating component 431 which generates a feedback dataset based on the metrics. In some embodiments, the feedback dataset may include normalization of the obtained metrics. In some embodiments, the adjustment component 430 may include a tuning component 432 which may generate one or more tuning commands either from the metrics or from the feedback dataset. The tuning commands may be generated in accordance with the adjustment protocols and the metrics. In some embodiments, the tuning commands may indicate one or more models or layers to be activated or deactivated, or one or more parameters or weights to be modified within a particular model, in response to the metrics or the feedback dataset. The adjustment component 430 may transmit the tuning commands to the base component 420.

FIG. 4B illustrates an example implementation of the navigation adjustment system 200, including how the input preparing component 402, the meta-learning component 203, the base component 420, and the adjustment component 430 collaborate, consistent with FIG. 4A. The input preparing component 402 may obtain inputs, which may include obtaining raw sensor data in step 452 and preprocessing the raw sensor data in step 454. The input preparing component 402 may generate feature vectors 457 in step 456 and transmit the feature vectors 457 to the meta-learning component 203. The input preparing component 402 may classify navigation conditions in step 458 and output one or more labels for the classified navigation conditions, as labelled navigation conditions 459. The input preparing component 402 may output the labelled navigation conditions 459 to the meta-learning component 203.

The meta-learning component 203 may generate base component initialization commands 463 in step 462 based on the feature vectors 457 and the labelled navigation conditions 459. The base component initialization commands 463 may include fine-tuned parameters corresponding to one or more models. The meta-learning component 203 may transmit the base component initialization commands 463 to the base component 420. The base component 420 may, after initialization based on the base component initialization commands 463, generate one or more navigation-related metrics 473 in step 472 during navigation of the ego vehicle 2. The base component 420 may transmit the navigation-related metrics 473 to the meta-learning component 203 and to the adjustment component 430. The meta-learning component 203 may, from the navigation-related metrics 473 or from the labelled navigation conditions 459, generate adjustment protocols 465 in step 464. In some embodiments, the meta-learning component 203 may generate initial adjustment protocols based on the labelled navigation conditions 459 and may update the adjustment protocols based on the navigation-related metrics 473.

The meta-learning component 203 may transmit the adjustment protocols 465 to the adjustment component 430. The adjustment component 430 may generate one or more tuning commands 483 in step 482, based on the metrics 473 and the adjustment protocols 465. The adjustment component 430 may transmit the tuning commands 483 to the base component 420. The tuning commands 483 may contain updated parameters for one or more specific tasks performed during navigation of the ego vehicle 2.

As an illustrative scenario, assume that current navigation conditions of the ego vehicle 2 include a snowy highway environment, as detected via the input preparing component 402 in step 458. The meta-learning component 203 may generate, or select, an initialization (e.g., initialization commands) that is optimized for such navigation conditions. The base component 420 may output driving actions based on these initialization commands. If any new challenges arise, such as icy patches, the base component 420 generates metrics to capture such challenges. The adjustment component 430 refines the base component 420 in an efficient and timely manner. Metrics are continuously generated by the base component 420 and transmitted to the adjustment component 430 as well as to the meta-learning component 203.

More generally, the navigation adjustment system 200 generates one or more initialization commands to initialize one or more models (e.g., machine learning models or classical models) for vehicle navigation. The initialization of the one or more models may be based on sensor data characterizing an environment within a threshold range of the ego vehicle 2, and based on one or more inductive inferences across historical (e.g., previously encountered) environments. The sensor data characterizing an environment may include navigation conditions. The initialization commands may modify or set one or more parameters within the one or more models. For example, the navigation adjustment system may infer a relationship between an extent of change of the navigation conditions and an extent of modification of the one or more parameters. In one specific example, if an amount of rain increases by a given amount of rain, then the one or more parameters may be modified by a given extent. As another example, the navigation adjustment system 200 may modify or set one or more parameters based on previously modified or set parameters for a similar set of navigation conditions. The navigation adjustment system 200 may initialize the one or more models based on the one or more initialization commands. The one or more initialized models may one or more navigation commands that, when executed, perform one or more navigation actions on the ego vehicle 2. in response to execution of the one or more navigation commands, the navigation adjustment system 200 may obtain one or more safety metrics that measure a level of safety or performance of the execution of the one or more navigation commands. If the level of safety or performance fails to satisfy a threshold level of safety or performance, the navigation adjustment system 200 executes a feedback loop which iteratively adjusts the one or more models and the one or more initialization commands. Iteratively adjusting the one or more initialization commands results in future initialization commands being more closely tailored to a set of navigation conditions, whether they are the same navigation conditions as the current environment or a different set of navigation conditions. The iteratively adjusted initialization commands may be part of the inductive inferences leveraged in future initialization commands. In some embodiments, the outputting of the adjusted navigation commands may include, outputting, based on the characterized environment, one or more adjustment protocols for generating a tuning command, generating the tuning command based on the one or more adjustment protocols, and applying the tuning command to adjust the one or more initialized models, wherein the adjusting of the one or more initialized models comprises adjusting one or more parameters corresponding to the one or more initialized models. During the feedback loop, the navigation adjustment system 200 outputs one or more adjusted navigation commands. After execution of the adjusted navigation commands, the navigation adjustment system 200 may obtain metrics related to a level of safety or performance of execution of the adjusted navigation commands. The navigation adjustment system 200 may, based on a level of safety of execution of the adjusted navigation commands, modify one or more of the adjustment protocols that regulate adjustment of the one or more initialized models. For example, if the adjusted navigation commands also fail to satisfy the threshold level of safety or performance, then the navigation adjustment system 200 may further modify the adjustment protocols until the further modified adjustment protocols result in the further adjusted navigation commands resulting from the further modified adjustment protocols satisfy the threshold level of safety or performance, or come closer to satisfying the threshold level of safety or performance. In some embodiments, the navigation adjustment system 200 may, based on sensor data characterizing a new environment, the one or more modified initialization commands, and one or more inductive inferences from the historical environments and the environment, generating one or more new initialization commands for vehicle navigation in the new environment. That is, one or more modified initialization commands may be part of the inductive inferences used to generate one or more new initialization commands for the new environment. In this manner, the navigation adjustment system 200 adapts to new and changing environments.

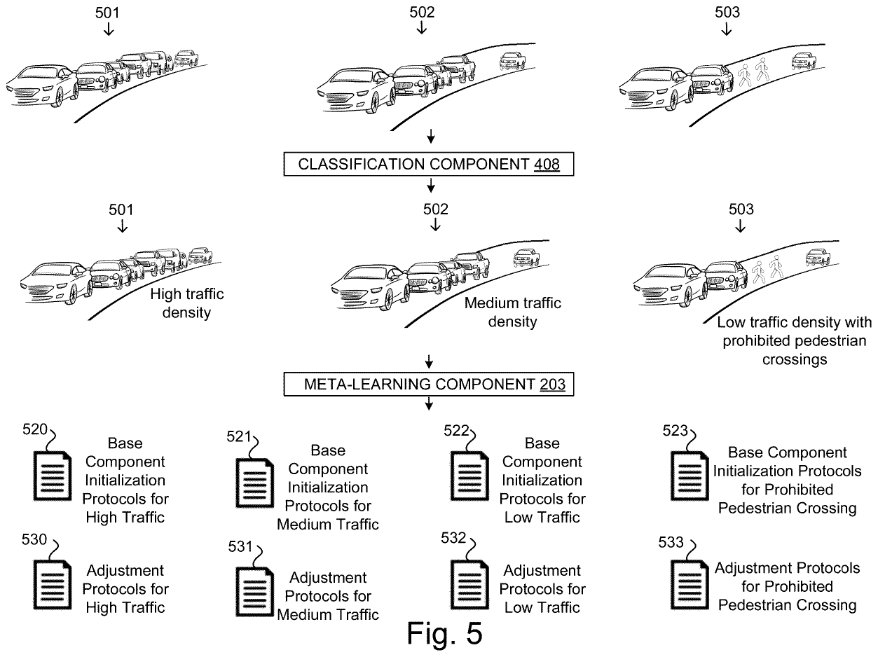

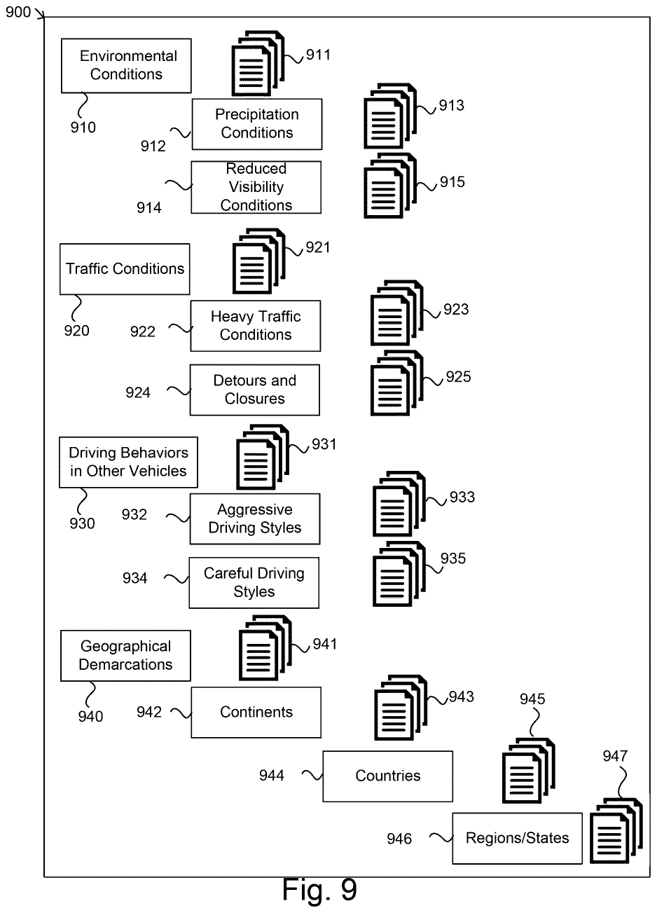

FIGS. 5-8 illustrate example implementations of the navigation adjustment system 200 according to different navigation conditions. FIGS. 5-8 illustrate how the meta-learning component 203 is configured to expand a set of encompassed navigation conditions over a period of time. Encompassed navigation conditions may include a set of conditions for which the meta-learning component 203 is programmed to initialize the base component 420 and to perform adjustments via adjustment protocols. In FIG. 5, assume over time that the input preparing component 402 obtains sensor data 501, 502, and 503 indicative of different navigation conditions. In some embodiments, the navigation conditions may correspond to different levels, types, or distributions of traffic. The sensor data 501, 502, and 503 may correspond to high traffic density, medium traffic density, and low traffic density with prohibited pedestrian crossings, respectively, as labelled by the classification component 408. For each of the different navigation conditions, the meta-learning component 203 may generate or store a set of base component initialization protocols and adjustment protocols. In some embodiments, the base component initialization protocols include base component initialization commands. In some embodiments, the base component initialization protocols may additionally include criteria of selecting one or more base component initialization commands. In some embodiments, the meta-learning component 203 may generate or store criteria of selecting one or more adjustment protocols. The meta-learning component 203 may generate or store base component initialization protocols 520, 521, 522, 523 corresponding to high traffic, medium traffic, low traffic, or for situations in which prohibited pedestrian crossing occurs. The meta-learning component 203 may generate or store adjustment protocols 530, 531, 532, 533 corresponding to high traffic, medium traffic, low traffic, or for situations in which prohibited pedestrian crossing occurs. In some embodiments, the base component initialization protocols 520, 521, 522, 523, base component initialization commands, or the adjustment protocols 530, 531, 532, 533 may be stored in one or more datasets. Example datasets are illustrated in FIG. 9.

As a result, if the ego vehicle 2 encounters such navigation conditions or similar navigation conditions, the meta-learning component 203 may retrieve one or more sets of stored base component initialization protocols or adjustment protocols corresponding to same or similar conditions. Alternatively, the meta-learning component 203 may derive different base component initialization protocols or adjustment protocols based on similar previously stored base component initialization protocols or adjustment protocols.

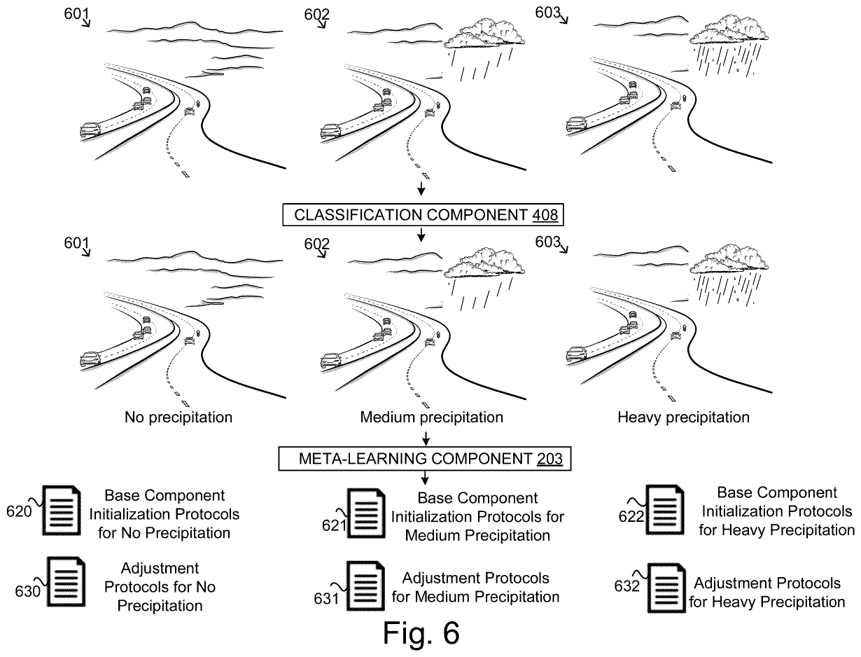

In FIG. 6, assume over time that the input preparing component 402 obtains sensor data 601, 602, and 603 indicative of different navigation conditions. In some embodiments, the navigation conditions may correspond to different levels, types, or distributions of traffic. The sensor data 601, 602, and 603 may correspond to no precipitation, medium precipitation, and heavy precipitation conditions, respectively, as labelled by the classification component 408. For each of the different navigation conditions, the meta-learning component 203 may generate or store a set of base component initialization protocols and adjustment protocols. The meta-learning component 203 may generate or store base component initialization protocols 620, 621, 622 corresponding to no precipitation, medium precipitation, and heavy precipitation. The meta-learning component 203 may generate or store adjustment protocols 630, 631, 632 corresponding to no precipitation, medium precipitation, and heavy precipitation conditions, respectively. As a result, if the ego vehicle 2 encounters such navigation conditions or similar navigation conditions, the meta-learning component 203 may retrieve one or more sets of stored base component initialization protocols or adjustment protocols corresponding to same or similar conditions. Alternatively, the meta-learning component 203 may derive different base component initialization protocols or adjustment protocols based on similar previously stored base component initialization protocols or adjustment protocols.

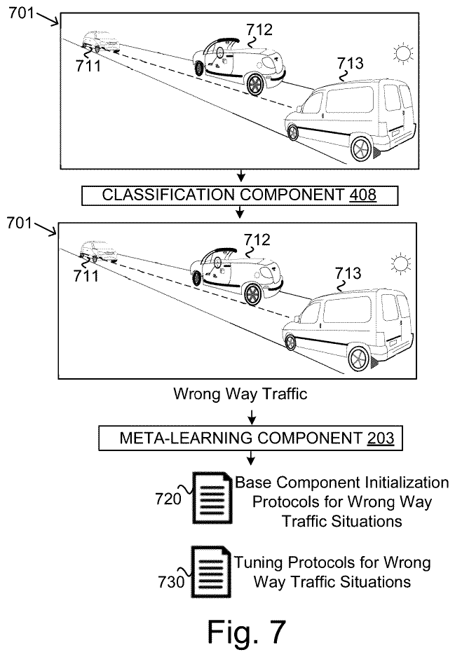

In FIG. 7, assume that the input preparing component 402 obtains sensor data 701 indicative of different navigation conditions such as driving behaviors. The sensor data 701 may indicate a presence of wrong way traffic, as labelled by the classification component 408. In particular, vehicles 713 and 712 are traveling in a correct direction while a vehicle 711 is travelling in a wrong direction. For each of the different navigation conditions, the meta-learning component 203 may generate or store a set of base component initialization protocols and adjustment protocols. The meta-learning component 203 may generate or store base component initialization protocols 720 corresponding to wrong way traffic situations. The meta-learning component 203 may generate or store adjustment protocols 730 corresponding to wrong way traffic situations. As a result, if the ego vehicle 2 encounters such driving behaviors or similar driving behaviors, the meta-learning component 203 may retrieve one or more sets of stored base component initialization protocols or adjustment protocols corresponding to same or similar conditions. Alternatively, the meta-learning component 203 may derive different base component initialization protocols or adjustment protocols based on similar previously stored base component initialization protocols or adjustment protocols.

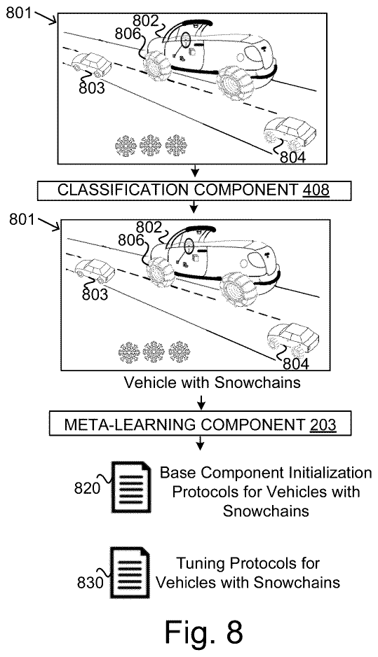

In FIG. 8, assume that the input preparing component 402 obtains sensor data 801 indicative of different vehicular conditions, such as presence of additional equipment or lack thereof. For example, this may include presence or absence of snowchains on a vehicle, which may indicate a decreased or increased probability of uncontrolled slippage or locomotion of another vehicle. In particular, vehicle 802 has snowchains 806, while vehicles 803 and 804 are devoid of snowchains. The classification component 408 may label the sensor data 801 to indicate that another vehicle has snowchains. The meta-learning component 203 may generate or store base component initialization protocols 820 corresponding to situations in which other vehicles have snowchains. The meta-learning component 203 may generate or store adjustment protocols 830 corresponding to situations in which other vehicles have snowchains. As a result, if the ego vehicle 2 encounters such vehicles with or without additional equipment, the meta-learning component 203 may retrieve one or more sets of stored base component initialization protocols or adjustment protocols corresponding to same or similar conditions. Alternatively, the meta-learning component 203 may derive different base component initialization protocols or adjustment protocols based on similar previously stored base component initialization protocols or adjustment protocols.

FIG. 9 is a diagram illustrating generated datasets of stored protocols or commands for initialization and tuning. In particular, FIG. 9 illustrates an example datastore 900, which may be implemented as part of the storage systems 250 or separate from the storage systems 250. The datastore 900 may be implemented as part of, or associated with, the meta-learning component 203. Example datasets 911, 913, 915, 921, 923, 925, 931, 933, 935, 941, 943, 945, and 947 may correspond to different navigation conditions. The example datasets may include protocols or commands for initialization and tuning, such as base component initialization commands and adjustment protocols, or additional criteria for selection or generating of such commands or protocols. The navigation conditions may be categorized or classified into environmental conditions 910, traffic conditions 920, driving behaviors 930 such as driving behaviors in other vehicles, and geographical demarcations 940. In some embodiments, the aforementioned categories may further be sub-categorized into subcategories. In some embodiments, the subcategories may be hierarchically organized with respect to other subcategories or the categories. The subcategories may include different levels of precipitation conditions 912, and different levels of reduced visibility conditions 914 under the environmental conditions category 910. The subcategories may include heavy traffic conditions 922 and situations with detours or road or lane closures 924 under the traffic conditions category 920. The subcategories may include aggressive driving styles 932 and careful or passive driving styles 934 under the driving behaviors category 930. The subcategories may include different continents 942, different countries 944 within particular continents, and different regions or states 946 within the different countries, under the geographical demarcations category 940.

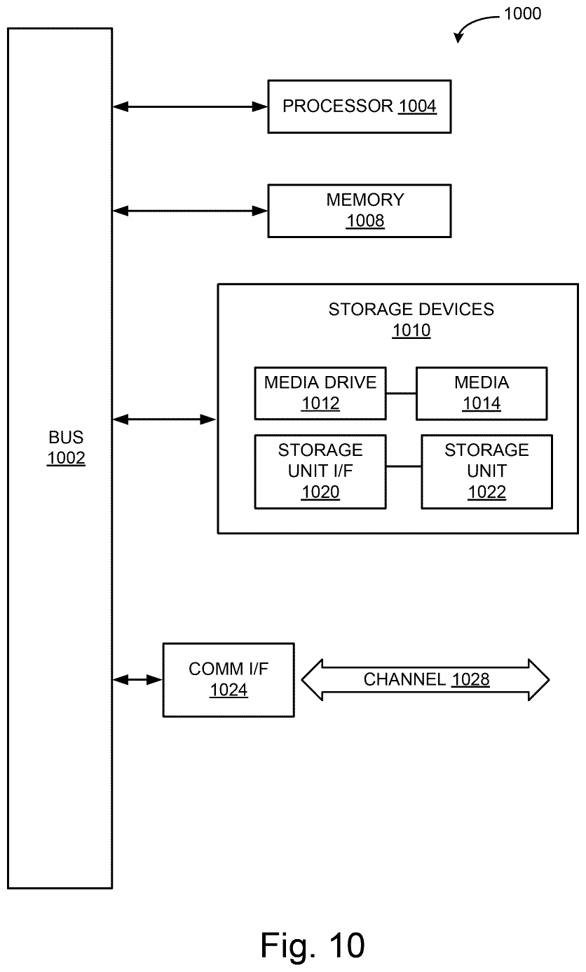

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various embodiments are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability.

Computing component 1000 might include, for example, one or more processors, controllers, control components, or other processing devices. This can include a processor, or any one or more of the components. Processor 1004 might be implemented using a general-purpose or special-purpose processing engine such as, for example, a microprocessor, controller, or other control logic. Processor 1004 may be connected to a bus 1002. However, any communication medium can be used to facilitate interaction with other components of computing component 1000 or to communicate externally.

Computing component 1000 might also include one or more memory components, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 1004.

The computing component 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, cartridge, optical disk, a CD or DVD. Storage media 1014 may be any other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component) and memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1024 may be carried on signals, which can be electronic, electromagnetic (which includes optical) or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to “near,” a “threshold” or “sufficiency” may be construed to encompass any applicable value or degree, such as any applicable value or degree sufficient to satisfy a given outcome. In some examples, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity, degree, or level may be construed as qualitatively satisfying some condition, such as presence of one or more common features. For example, a threshold level of safety may be construed as an absence of a safety-related event such as a disengagement, collision, or other accident, or not exceeding a given number or frequency of safety-related events. Reference to “likely,” “a likelihood,” or “probable” or any variation thereof may be construed as satisfying some threshold likelihood or probability.

In some embodiments, a threshold distance may refer to any distance in which an obstacle may have at least a threshold likelihood or probability of affecting one or more navigation actions or characteristics of the ego vehicle. In some embodiments, a threshold distance may refer to an acceptable following distance or maintaining distance according to one or more standards, such as one or more standards governing reaction time. For example, a threshold distance may include any distances equivalent to, or less than, 3 seconds, 10 seconds, or 20 seconds of travel at a current speed, or any subranges therein.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system associated with a vehicle, the system comprising:
one or more processors; and
a memory storing instructions that, when executed by the one or more processors, cause the system to perform:
based on sensor data characterizing an environment and based on one or more inductive inferences across historical environments, generating one or more initialization commands to initialize one or more models for vehicle navigation;
outputting, by the one or more initialized models, one or more navigation commands that, when executed, perform one or more navigation actions on the vehicle;
in response to execution of the one or more navigation commands, and depending on one or more safety metrics that measure a level of safety of the execution of the one or more navigation commands, selectively adjusting the one or more initialization commands and the one or more initialized models; and
based on sensor data characterizing a new environment, the one or more selectively adjusted initialization commands, and one or more inductive inferences across the historical environments and the environment, generating one or more new initialization commands for vehicle navigation in the new environment.

2. The system of claim 1, wherein the instructions that, when executed by the one or more processors, further cause the system to perform:
prior to generating the one or more initialization commands, preprocessing the sensor data, wherein the preprocessing comprises:
normalizing any different formats of the sensor data to a common format;
temporally aligning the sensor data;
extracting one or more features based on the normalized and temporally aligned sensor data; and
generating one or more feature vectors corresponding to the one or more extracted features; and
generating one or more classification labels to classify the normalized and temporally aligned sensor data; and wherein:
the generating of the one or more initialization commands is based on the one or more classification labels and the one or more feature vectors.

3. The system of claim 2, wherein the sensor data comprises camera data or Lidar data, temporally aligning of the sensor data comprises synchronizing the sensor data with inertial readings from one or more inertial measurement units (IMUs), the one or more initialization commands modify or set one or more parameters within the one or more models, and the instructions that, when executed by the one or more processors, cause the system to perform initializing the one or more models based on the one or more initialization commands.

4. The system of claim 1, wherein the safety metrics comprise a minimum following distance over a period of time and a degree of conformity in following a lane, and selectively adjusting the one or more initialization commands comprises:
in response to the level of safety failing to satisfy a threshold level of safety:
based on a type or an extent of a safety failure, adjusting the one or more initialization commands and at least one of the one or more initialized models;
outputting, by the one or more adjusted initialized models, one or more adjusted navigation commands; and
based on a level of safety of execution of the adjusted navigation commands, modifying one or more adjustment protocols that regulate adjustment of the one or more initialized models.

5. The system of claim 1, wherein the adjusting of the one or more initialized models comprises:
outputting, based on the characterized environment, one or more adjustment protocols for generating a tuning command;
generating the tuning command based on the one or more adjustment protocols; and
applying the tuning command to adjust the one or more initialized models, wherein the adjusting of the one or more initialized models comprises adjusting one or more parameters corresponding to the one or more initialized models.

6. The system of claim 5, wherein the instructions that, when executed by the one or more processors, further cause the system to perform:
modifying the one or more adjustment protocols;
in response to a level of safety of execution of the adjusted navigation commands failing to satisfy the threshold level of safety, further modifying the one or more adjustment protocols until the level of safety of execution of the one or more further modified adjustment protocols satisfies the threshold level of safety.

7. The system of claim 1, wherein the initializing of the one or more models comprises activating a subset of the one or more models and deactivating one or more remaining models, and the sensor data comprises one or more navigation conditions of the environment, the navigation conditions comprising any of weather conditions, visibility conditions, traffic conditions, and road geometry conditions.

8. The system of claim 7, wherein the one or more models, prior to initialization, are configured to output one or more navigation commands for a different set of navigation conditions.

9. The system of claim 5, wherein the instructions that, when executed by the one or more processors, further cause the system to perform:
modifying the one or more adjustment protocols based on historical modifications to one or more previous adjustment protocols and extents to which the historical modifications resulted in a level of safety of execution that satisfied the threshold level of safety.

10. The system of claim 1, wherein the one or more new initialization commands modify one or more different parameters within the one or more models, the one or more new initialization commands are configured to output one or more new navigation commands specific for the new environment; and the instructions that, when executed by the one or more processors, further cause the system to perform:
performing a new initialization on the one or more models based on the one or more new initialization commands;
outputting, by the one or more newly initialized models, the one or more new navigation commands that, when executed, perform the one or more navigation actions or new navigation actions on the vehicle;
in response to execution of the one or more new navigation commands, obtaining one or more new metrics that measure a new level of safety of the execution of the one or more new navigation commands;
in response to the new level of safety failing to satisfy a threshold degree of safety: based on a type or an extent of a safety failure, adjusting the one or more new initialization commands and at least one of the one or more newly initialized models;
outputting, by the one or more adjusted newly initialized models, one or more adjusted new navigation commands;
based on a degree to which resulting execution of the adjusted new navigation commands satisfies the threshold degree of safety, modifying one or more new adjustment protocols that regulate adjustment of the one or more newly initialized models; and
based on sensor data characterizing the environment, the one or more adjusted new navigation commands, and one or more inductive inferences from the historical environments, the new environment, and the environment, generating one or more second modified initialization commands for vehicle navigation in the new environment.

11. A computer-implemented method comprising:
based on sensor data characterizing an environment and based on one or more inductive inferences across historical environments, generating one or more initialization commands to initialize one or more models for vehicle navigation;
outputting, by the one or more initialized models, one or more navigation commands that, when executed, perform one or more navigation actions on the vehicle;
in response to execution of the one or more navigation commands, and depending on one or more performance metrics that measure a level of performance of the execution of the one or more navigation commands, selectively adjusting the one or more initialization commands and the one or more initialized models; and
based on sensor data characterizing a new environment, the one or more selectively adjusted initialization commands, and one or more inductive inferences across the historical environments and the environment, generating one or more new initialization commands for vehicle navigation in the new environment.

12. The computer-implemented method of claim 11, further comprising:
prior to generating the one or more initialization commands, preprocessing the sensor data, wherein the preprocessing comprises:
normalizing any different formats of the sensor data to a common format; temporally aligning the sensor data;
extracting one or more features based on the normalized and temporally aligned sensor data; and
generating one or more feature vectors corresponding to the one or more extracted features; and
generating one or more classification labels to classify the normalized and temporally aligned sensor data; and wherein:
the generating of the one or more initialization commands is based on the one or more classification labels and the one or more feature vectors.

13. The computer-implemented method of claim 12, wherein the sensor data comprises camera data or Lidar data, and the temporally aligning of the sensor data comprises synchronizing the sensor data with inertial readings from one or more inertial measurement units (IMUs), the one or more initialization commands modify or set one or more parameters within the one or more models, and the computer-implemented method further comprises initializing the one or more models based on the one or more initialization commands.

14. The computer-implemented method of claim 11, wherein the performance metrics comprise a minimum following distance over a period of time and a degree of conformity in following a lane, and selectively adjusting the one or more initialization commands comprises:
in response to the level of safety failing to satisfy a threshold level of safety:
based on a type or an extent of a safety failure, adjusting the one or more initialization commands and at least one of the one or more initialized models;
outputting, by the one or more adjusted initialized models, one or more adjusted navigation commands; and
based on a level of safety of execution of the adjusted navigation commands, modifying one or more adjustment protocols that regulate adjustment of the one or more initialized models.

15. The computer-implemented method of claim 11, wherein the adjusting of the one or more initialized models comprises:
outputting, based on the characterized environment, one or more adjustment protocols for generating a tuning command;
generating the tuning command based on the one or more adjustment protocols; and
applying the tuning command to adjust the one or more initialized models, wherein the adjusting of the one or more initialized models comprises adjusting one or more parameters corresponding to the one or more initialized models.

16. The computer-implemented method of claim 15, further comprising:
modifying the one or more adjustment protocols; and
in response to a level of performance of the adjusted navigation commands failing to satisfy the threshold level of performance, further modifying the one or more adjustment protocols until the level of performance of execution of the one or more further modified adjustment protocols satisfy the threshold level of performance.

17. The computer-implemented method of claim 11, wherein the initializing of the one or more models comprises activating a subset of the one or more models and deactivating one or more remaining models, and the sensor data comprises one or more navigation conditions of the environment, the navigation conditions comprising any of weather conditions, visibility conditions, traffic conditions, and road geometry conditions.

18. The computer-implemented method of claim 11, wherein the one or more models, prior to initialization, are configured to output one or more navigation commands for a different set of navigation conditions.

19. The computer-implemented method of claim 15, further comprising modifying the one or more adjustment protocols based on historical modifications to one or more previous adjustment protocols and extents to which the historical modifications resulted in a level of performance of execution that satisfied the threshold level of performance.

20. The computer-implemented method of claim 11, wherein the one or more new initialization commands modify one or more different parameters within the one or more models, the one or more new initialization commands are configured to output one or more new navigation commands specific for the new environment; and the computer-implemented method further comprises:
performing a new initialization on the one or more models based on the one or more new initialization commands;
outputting, by the one or more newly initialized models, the one or more new navigation commands that, when executed, perform the one or more navigation actions or new navigation actions on the vehicle;
in response to execution of the one or more new navigation commands, obtaining one or more new metrics that measure a new level of performance of the execution of the one or more new navigation commands;
in response to the new level of performance failing to satisfy a threshold level of performance:
based on a type or an extent of a performance failure, adjusting the one or more new initialization commands and at least one of the one or more newly initialized models;
outputting, by the one or more adjusted newly initialized models, one or more adjusted new navigation commands;
based on a level to which resulting execution of the adjusted new navigation commands satisfies the threshold level of performance, modifying one or more new adjustment protocols that regulate adjustment of the one or more newly initialized models; and
based on sensor data characterizing the environment, the one or more adjusted new navigation commands, and one or more inductive inferences from the historical environments, the new environment, and the environment, generating one or more second modified initialization commands for vehicle navigation in the new environment.
